(19) United States
(12) Patent Application Publication
(10) Pub. No.: US 2025/0258038 A1
(43) Pub. Date: Aug. 14, 2025

(54) SAMPLE ILLUMINATION SYSTEMS AND RELATED METHODS

(71) Applicant: Gemological Institute of America, Inc., Carlsbad, CA (US)

(72) Inventors: Tsung-Han TSAI, Maywood, NJ (US); RJ PISANI, Brooklyn, NY (US); Barak ERGI, Fairlawn, NJ (US); Mehdi TOOSI, Clifton, NJ (US); William RUSSOTTO, North Bergen, NJ (US); Simon LAWSON, Carlsbad, CA (US); Hiroshi TAKAHASHI, Morristown, NJ (US)

(21) Appl. No.: 19/048,001

(22) Filed: Feb. 7, 2025

Related U.S. Application Data
(60) Provisional application No. 63/551,417, filed on Feb. 8, 2024.

(51) Int. Cl. G01J 3/10; G01J 3/50; G01N 21/87; G02B 27/28

(52) U.S. Cl. CPC G01J 3/10; G01J 3/501; G01N 21/87; G02B 27/283; G01J 2003/102

(57) ABSTRACT

Systems and methods used to illuminate samples are disclosed. An illumination system includes a stage to support a sample thereon, a first electromagnetic (EM) radiation source to provide first EM radiation, a second EM radiation source to provide second EM radiation, and optical equipment to combine at least a portion of the first EM radiation with at least a portion of the second EM radiation to provide combined EM radiation to the stage to illuminate the sample. A method of illuminating a sample includes illuminating a first input of a dichroic beam splitter with white light from a white light emitting diode (LED), illuminating a second input of the dichroic beam splitter with ultraviolet (UV) light from a UV LED, and directing combined light from an output of the dichroic beam splitter toward the sample.

### CROSS-REFERENCE TO RELATED APPLICATIONS

This application claims the benefit of U.S. Provisional Application No. 63/551,417, filed Feb. 8, 2024, the entire disclosure of which is hereby incorporated herein by this reference.

### TECHNICAL FIELD

The field includes systems and methods for illumination and improving viewing of and image capture of samples, which may be used for various analyses including color evaluation.

### BACKGROUND

Halogen light bulbs may be used by diamond color grading systems. After more than 30 minutes warmup and with frequent background calibration, halogen lights are considered stable enough for color measurement. Unfortunately, halogen lights may not be frequently turned on and off in order to maintain the desired light stability due to relatively long warmup times. Bright halogen light bulbs may also soon be discontinued due to environmental regulations. Also, halogen light bulbs may not provide a consistent output spectrum or generate the desired type of light distribution for color grading and other sample analysis. The relatively short lifetimes of halogen light bulbs is another concern, which is typically less than 1,000 hours of on time. Furthermore, bright light from halogen light bulbs may create a radiation hazard to a person using a color grading system.

White light emitting diode (LED) light may be a potential replacement to halogen light. conventional white LEDs may typically achieve a color rendering index (CRI) of less than 80, making the output spectrum quite different from that of halogen lights. In addition, output spectra of white LEDs do not typically include ultraviolet (UV) components, which may be helpful for diamond color grading and other sample analysis.

### BRIEF SUMMARY

In some embodiments, an illumination system includes a stage to support a sample thereon, a first electromagnetic (EM) radiation source to provide first EM radiation, a second EM radiation source to provide second EM radiation, and optical equipment to combine at least a portion of the first EM radiation with at least a portion of the second EM radiation to provide combined EM radiation to the stage to illuminate the sample.

In some embodiments, a method of illuminating a sample includes illuminating a first input of a dichroic beam splitter with white light from a white light emitting diode (LED), illuminating a second input of the dichroic beam splitter with ultraviolet (UV) light from a UV LED, and directing combined light from an output of the dichroic beam splitter toward the sample.

Various systems and methods disclosed herein may be used to illuminate gemstones, including using a high CRI value white LED configured to emit a beam through a color filter and collimation lens and to a dichroic beam splitter; a UV LED configured to emit a beam through a UV lens and through an ND filter to reduce brightness, and to the dichroic beam splitter; a gemstone stage, wherein the dichroic beam splitter configured to combine the white LED beam and UV beam and direct the combined beam through a second lens and through a third lens to a fiber wherein the fiber is in communication with a ring light configured to illuminate the gemstone stage. The white LED and UV LED each include a temperature sensor and heat sink, and are each independently configurable for brightness. The temperature sensors are in communication with a computing system with a processor and memory. The computing system is configured to analyze temperature data from the temperature sensors.

In some examples, systems and methods disclosed herein may be used to illuminate a gemstone. A system includes a stage configured to support the gemstone, a high CRI white LED, a UV LED, a dichroic beam splitter configured to merge a beam of light emitted from the high CRI white LED light with a beam of light emitted from the UV LED light to create a resultant beam directed toward the gemstone. The dichroic beam splitter allows the white light to pass through it and reflect the UV light. In some examples, the UV LED light to white LED light ratio may be adjusted by the computer system. In some examples, the adjustment is to change intensity of either the white or the UV light based on data received from the temperature sensors. In some examples, the adjustment is to change intensity of either the white or the UV light based on data received from current sense resistors that provide feedback on current draws of the white LED and UV LED. In some examples, the high CRI white LED light and UV LED light are in thermal contact with a heat sink. In some examples, the high CRI white LED light heat sink includes a cooling fan. In some examples, the UV LED light heat sink includes a cooling fan. In some examples, the high CRI white LED light heat sink includes a temperature sensor in communication with a computer system having a processor and memory. In some examples, the UV LED light heat sink includes a UV LED temperature sensor 146 in communication with the computer system 148 having a processor and memory. In some examples, the heat sink is configured to keep the high CRI white LED operating at a temperature of between 35 and 45 degrees Celsius (C). In some examples, the heat sink is configured to keep the UV LED operating at a temperature of between 25 to 40 degrees C. In some examples, the white LED includes a color filter. In some examples, the white LED includes a collimating lens. In some examples, the white LED includes a neutral density (ND) filter. In some examples, the dichroic beam splitter includes at least one lens to focus the resultant beam toward the gemstone. Some examples further comprise a spectrometer configured to record the LED total output spectrum at the white LED and the UV LED and combined resultant beam. In some examples, the white LED and the UV LED are individually adjustable to adjust the output of the respective LED. In some examples, the resultant beam has a color temperature between 5000 to 6500K. In some examples, the resultant beam has a CRI greater than 90.

In some examples, systems and methods may include receiving, at a computer with a processor and a memory, temperature data from a heat sink in thermal contact with a high CRI white LED; receiving, at the computer, temperature data from a heat sink in thermal contact with a UV LED; receiving, at the computer, spectrometer data from a spectrometer measuring a beam of light including combined light from the high CRI white LED and the UV LED; comparing, at the computer, the spectrometer data to a reference brightness value; and sending commands from the computer to the high CRI white LED and the UV LED to adjust brightness to minimize any difference between the spectrometer data and the reference brightness value. In some examples, the temperature data from the heat sink in thermal contact with the high CRI white LED or UV LED is from an LED case. In some examples, the temperature data from the heat sink in thermal contact with the high CRI white LED or UV LED is from a heat sink substrate. In some examples, the methods include monitoring, by the computer, LED current draw for both the white LED and the UV LED via current sensor ICs on an LED control board.

### BRIEF DESCRIPTION OF THE DRAWINGS

For a better understanding of the embodiments described in this application, reference should be made to the Detailed Description below, in conjunction with the following drawings in which like reference numerals refer to corresponding parts throughout the figures.

FIG. 1A illustrates an example system to analyze a sample, according to some embodiments;

FIG. 1B is an isometric view of the example system illustrated by FIG. 1A taken from a perspective angle and with some three-dimensional parts shown;

FIG. 2 is a block diagram of an electrical system, according to some embodiments;

FIG. 3 is a flowchart illustrating a method of illuminating a sample, according to some embodiments;

FIG. 4 is a flowchart illustrating a method of operating an illumination system, according to some embodiments;

FIG. 5 is a flowchart illustrating a method of monitoring an LED output spectrum;

FIG. 6 is a method of estimating brightness of a white LED, according to some embodiments;

FIG. 7 is a method of estimating a brightness of a UV LED, according to some embodiments;

FIG. 8 is a method of illuminating a sample, according to some embodiments;

FIG. 9 is flowchart illustrating another method of illuminating a sample, according to some embodiments;

FIG. 10 is a diagram of an example networked system in accordance with certain aspects described herein; and

FIG. 11 is a diagram of an example computer system in accordance with certain aspects described herein.

### DETAILED DESCRIPTION

Reference will now be made in detail to embodiments, examples of which are illustrated in the accompanying drawings. In the following detailed description, numerous specific details are set forth in order to provide a sufficient understanding of the subject matter presented herein. But it will be apparent to one of ordinary skill in the art that the subject matter may be practiced without these specific details. Moreover, the particular embodiments described herein are provided by way of example and should not be used to limit the scope of the particular embodiments. In other instances, well-known data structures, timing protocols, software operations, procedures, and components have not been described in detail so as not to unnecessarily obscure aspects of the embodiments herein.

To accurately color grade a diamond, specific features of a light source are helpful. A halogen light bulb may produce light that includes these helpful features, but halogen light bulbs may introduce several drawbacks. Systems and methods disclosed herein may be used instead of a halogen bulb for diamond color grading and other sample analysis systems.

A UV component in a light source is helpful in viewing a sample such as a diamond for color grading and other analysis. For example, 365 nm wavelength light may be helpful for diamond color grading. Filtered mercury lamps may be used in fluorescence measurements, but for strongly fluorescent diamonds, the excited fluorescence due to these filtered mercury lamps could change the color grade of a diamond as compared to what the color grade would be if halogen light were used. White LEDs typically do not include a UV component similar to that provided in light sources in halogen light based color grading systems, and may therefore be insufficient if used alone in color grading systems.

Systems and methods according to various embodiments disclosed herein may provide reliable, updated, and improved light sources compared to conventional light sources for color grading samples (e.g., diamonds) by human and also by digital image capture and analysis.

Systems and methods according to various embodiments disclosed herein include light sources that provide light that is helpful in diamond color grading, which involves light sources having specific qualities and functionality. Some examples of such light sources, each alone or in any combination or permutation, may include one or more of the following: a correlated color temperature between 5000 to 6500 degrees Kelvin (K); illumination that is bright enough for color measurement by a person or by camera; a color rendering index (CRI) greater than 90; a system that is designed to include ultra violet wavelength components; a system that can have a long lifetime with LEDs having a lifetime expectancy of 10,000 hours as compared to halogen bulbs at less than 1,000 hours; a system that is spectrally stable (giving the same output spectrum over time); a system that is stable in brightness, approximately ±0.5% (short term stability); a system that can be utilized and still follow all safety regulations for radiation and exposure for human eyes; a system that is environmentally friendly (for example avoiding frequent replacement of lightbulbs); a system that meets the pre-defined light propagation requirement; a system that can be used with the current color measurement device; a system with light output similar to a halogen lamp such as the Schott KL1500. Such a system may include no moving parts, which is advantageous for maintenance, system longevity and better for using fiber optics between and among the system component parts. Such a system may be compact and relatively portable as well which is useful for storage and utilization at different locations.

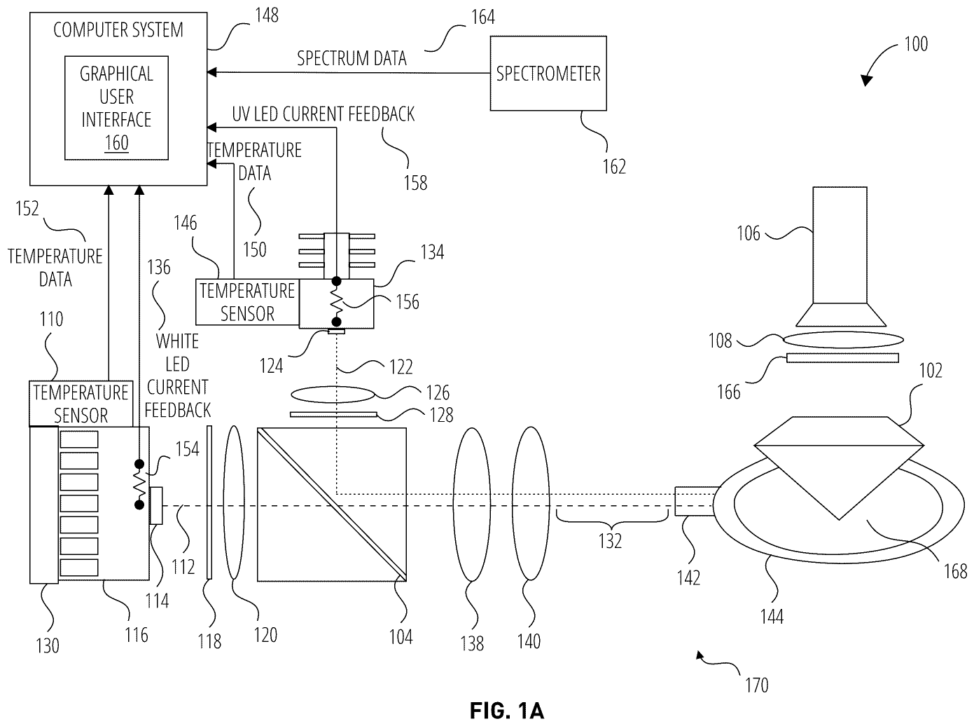

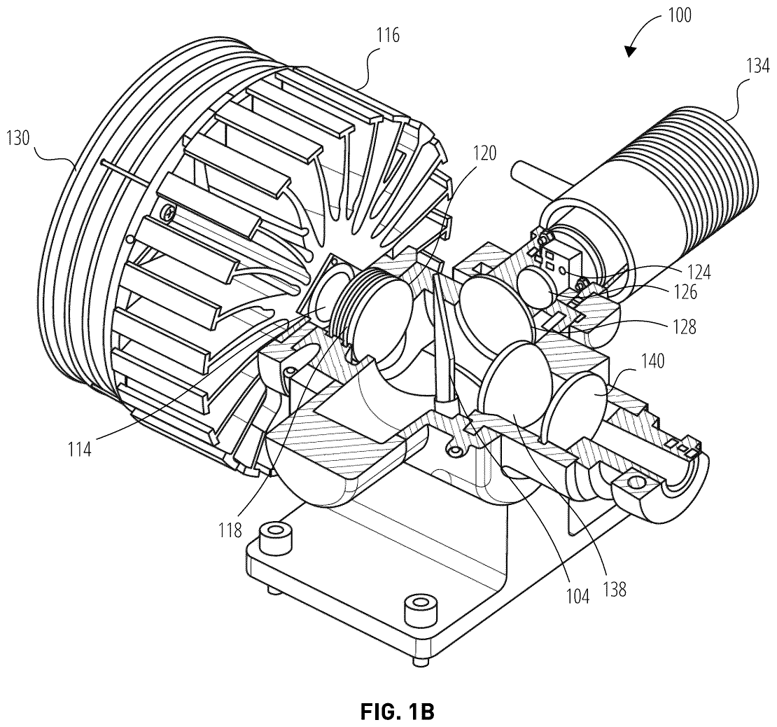

FIG. 1A illustrates an example system 100 to analyze a sample, according to some embodiments. The system 100 includes an illumination system 170 to illuminate the sample (e.g., a sample gemstone 102) such as a diamond for either digital imaging or human analysis. By way of non-limiting example, the system 100 may be used for color grading. In such examples, a camera 106 with a filter 166 and an imaging lens 108 may be used to capture digital images of the sample gemstone 102. In some examples, instead of a camera, a human may use a lens or other viewing article to observe the gemstone 102 illuminated according to systems and methods disclosed herein.

The system 100 includes a stage 168 to support the sample (e.g., the sample gemstone 102) thereon. The illumination system 170 illuminates the sample supported on the stage 168. The illumination system 170 includes a first electromagnetic (EM) radiation source (e.g., a white LED 114 such as a high CRI white LED) to provide first EM radiation (e.g., white light 112), a second EM radiation source (e.g., an ultraviolet (UV) LED 124) to provide second EM radiation (e.g., UV light 122), and optical equipment to combine at least a portion of the first EM radiation with at least a portion of the second EM radiation to provide combined EM radiation (e.g., combined light 132) to the stage 168 to illuminate the sample.

The optical equipment includes a beam splitter (e.g., a dichroic beam splitter 104) to combine at least a portion of the first EM radiation with at least a portion of the second EM radiation to provide the combined EM radiation to the sample. In the example system 100 illustrated in FIG. 1A, the optical equipment also includes a color filter 118 and a collimating lens 120 in front of the white LED 114 (between the white LED 114 and the dichroic beam splitter 104), a UV LED lens 126 and a neutral density (ND) filter 128 in front of the UV LED 124 (between the UV LED 124 and the dichroic beam splitter 104), a fiber optic line 142, and a ring light 144 optically coupled to the fiber optic line 142. The fiber optic line 142 is positioned to receive the combined light 132 and deliver the combined light 132 to the ring light 144. The ring light 144 is positioned at (e.g., proximate to) the stage 168 to illuminate the sample. The optical equipment further includes lenses 138, 140 between the dichroic beam splitter 104 and the fiber optic line 142.

By way of non-limiting example, the white LED 114, the UV LED 124, and the optical equipment may be selected to approximate filtered halogen illumination with the combined light 132, the filtered halogen illumination including halogen illumination filtered by a color adjusting daylight filter. For example, the color filter 118 may be selected to pass spectral elements associated with sunlight and filter out other spectral elements to mimic a daylight spectrum. The system 100 also includes a computer system 148 configured to control electrical currents provided to the white LED 114 and the UV LED 124. Adjustments to these electrical currents may adjust brightness/intensity of the white LED 114 and the UV LED 124, which gives the computer system 148 control over a ratio between white light components and UV light components of the combined light 132. Accordingly, the computer system 148 may adjust the electrical currents provided to the white LED 114 and the UV LED 124 to set a target ratio between the white light components and UV light components in the combined light 132. By way of non-limiting example, the target ratio may be selected to approximate filtered halogen illumination with the combined light 132.

The system 100 includes temperature sensors (e.g., white LED temperature sensor 110 at the white LED, UV LED temperature sensor 146 at the UV LED 124) that provide temperature data (e.g., white LED temperature data 152 from the white LED temperature sensor 110, UV LED temperature data 150 from the UV LED temperature sensor 146) to the computer system 148. The computer system 148 may control the electrical currents provided to the white LED 114 and the UV LED 124 based, at least in part, on the temperature data from the temperature sensors.

The system 100 includes current sense resistors (e.g., white LED current sense resistor 154 at the white LED 114, UV LED current sense resistor 156 at the UV LED 124) that provide current feedback (e.g., white LED current feedback 136 associated with the white LED 114, UV LED current feedback 158 associated with the UV LED 124) indicative of electrical currents provided to the white LED 114 and the UV LED 124. The computer system may be configured to control the electrical currents provided to the white LED 114 and the UV LED 124 based, at least in part, on the current feedback from the current sense resistors.

The system 100 includes a spectrometer 162 to provide, to the computer system 148, spectrum data 164 indicating measured spectra of one or more of the white light 112, the UV light 122, or the combined light 132. The computer system 148 may be configured to control the electrical currents provided to the white LED 114 and the UV LED 124 based, at least in part, on the spectrum data 164.

The temperatures at the white LED 114 and the UV LED 124, the current feedback indicating the electrical currents provided to the white LED 114 and the UV LED 124, and the spectrum data 164 may provide the computing computer system 148 clues to ratios between white light components and UV light components in the combined light 132. The computing system may use these clues to determine adjustments to be made to the electrical currents provided to the white LED 114 and the UV LED 124 to achieve a desired ratio between white light components and UV light components of the combined light 132.

In the example illustrated in FIG. 1A, the system 100 includes the dichroic beam splitter 104 to merge a beam of white light 112 from a high CRI white Light Emitting Diode (LED) 114 with a beam of UV light 122 from a UV LED 124 to create a resultant beam of combined light 132 that meets the light source requirements for diamond 102 color measurement. This combination of specific wavelengths of light energy, created by the LED, may enable the computer system 148 to control the combined light 132 to approximate various different lighting conditions in an economical and sustainable way.

In some examples, the combined light 132 may directly illuminate the target gemstone 102. In some examples, the combined light 132 may be relayed using a fiber optic line 142 of any useful length, to a fiber ring light 144. By this ring light 144, the gemstone 102 may be illuminated from a surrounding 360 degrees and allow imaging from the table side, or any other angle. In some examples, the fiber optic line 142 may relay the combined light 132 to an illuminated stage, a series of ring lights, directional lights, and/or any other combination or permutation of light environments to illuminate a target (e.g., sample gemstone 102). The ring light 144 shown in FIG. 1A is merely a non-limiting example.

In some examples, the combined output beam 132 has a color temperature between 5000 to 6500K. In some examples, the combined output beam 132 has a Color Rendering index (CRI) greater than 90.

One advantage of such a system is that the UV LED 124 light intensity to white LED 114 light intensity ratio may be adjusted independently of one another. For example, in some examples, it may be useful to change the intensity or other features of either the white light 112 and/or the UV light 122 for the system. By separating the UV source (UV LED 124) from the white light source (white LED 114), each may be separately adjusted, sources replaced, or otherwise turned on or off. This allows for many multiple variations and adjustments available for the system and provides flexibility for the operator.

As shown in the example system of FIG. 1A, the respective LED systems may be in thermal contact with a respective heat sink. Such an example heat sink temperature may be correlated with the brightness of the LED. Thus, as shown in FIG. 1, the white LED 114 is in thermal contact with a heat sink 116. In some examples, a heat sink may be made of a material that dissipates heat quickly. In some examples, a heat sink may include fins or other features that increase surface area of the heat sink to dissipate heat quickly. In some examples, a heat sink may be made of metal such as aluminum, copper, or alloys of aluminum and/or copper, or a ceramic material. In some examples, this heat sink 116 includes an integrated cooling fan 130. For temperature monitoring, a cooling fan 130 can help to reach an equilibrium temperature faster than without a fan. For example, it might take 2 minutes to reach equilibrium temperature if there is no heatsink and fan, but it only takes 5 seconds with heat sink 116 and cooling fan 130 combination.

Such a heat sink 116 may be used to cool the white LED 114 to keep it operating at a range of desired working temperatures with a heat sink 116 and cooling fan 130 combination that maintains its output at the desired intensity and wavelength. In some examples, this desired target temperature of the white LED 114 is between 35 and 45 degrees C. as measured at the heat sink 116 using a white LED temperature sensor 110. Such a temperature target is measured in a corresponding room temperature of 20 to 30 degrees C. In some examples, one or more white LED temperature sensors 110 are attached to the heat sink 116 or otherwise in thermal contact with or within sensory range to be able to sense a current white LED temperature data 152 of the corresponding white LED 114 and/or heat sink 116 and send white LED temperature data 152 to a computer system 148. In such a way, by placing such sensors (e.g., white LED temperature sensor 110) in communication with the computer system 148, the heat sink 116 and/or LED temperatures may be monitored automatically by the computer system 148 and/or manually or by human operator using a computerized display of temperature data (e.g., via a graphical user interface 160). In some examples, monitoring the LED junction temperature will be more accurate, but it is not always possible to have access to the junction temperature, where the junction temperature is temperature measured directly from the LED chip. For example, any kind of connection or boundary creates a heat buffer, such as LED to PCB and/or PCB to heat sink. These buffers will create a temperature gradient, which can lower the temperature reading, compared to the junction temperature. In various embodiments, white LED temperature sensors 110 may be placed to measure any combination or permutation of the above components of the system.

In some examples, a white LED current sense resistor 154 may be used to estimate an electrical current provided to the white LED 114. By way of non-limiting example, the white LED current sense resistor 154 may be placed in series with or in parallel with the white LED 114, and a voltage potential across the white LED current sense resistor 154 may be detected. A known resistance of the white LED current sense resistor 154, estimated electrical impedance of the white LED 114, and a known voltage potential across the white LED current sense resistor 154 may be used to estimate the electrical current provided to the white LED 114. In some examples, white LED current feedback 136 may be provided to the computer system 148 to enable the computer system 148 to estimate the current provided to the white LED 114. By way of non-limiting example, the white LED current feedback 136 may be indicative of a voltage potential across of the white LED current sense resistor 154. The computer system 148 may use the determined electrical current provided to the white LED 114 to estimate a brightness/intensity of the white LED 114. By way of non-limiting example, the computer system 148 may correlate various electrical current values with corresponding estimated brightness/intensity values. As a result, given a determined electrical current provided to the white LED 114, the computer system 148 may determine a corresponding estimated brightness/intensity value. Interpolation (e.g., linear interpolation) between stored values for the electrical current and the corresponding brightness/intensity and/or extrapolation may be used to estimate the brightness/intensity of the white LED 114 based on determined electrical current values that do not match those stored by the computer system 148.

In some examples, the white LED 114 may achieve greater than 97 CRI. In some examples, as shown in FIG. 1A, the white LED 114 arrangement may include a color filter 118. Such a color filter 118 may be used to balance the LED spectrum of the white light 112 and make the output spectrum closer to that of sunlight. A spectrum of light 112 from the white LED 114 may be different from that of sunlight. Accordingly, the color filter 118 may be selected to filter out components of the spectrum of the light 112 from the white LED 114 that are less prevalent in sunlight and pass components of the light 112 that are more prevalent in sunlight (e.g., −500 nm wavelength). The color filter 118 may result in providing components of the spectrum of the light 112 to the gemstone 102 that enables more accurate color detection than if the light 112 were unfiltered. As shown in FIG. 1A, the white LED 114 arrangement may include a collimating lens 120 to focus the beam of white light 112. One example of an LED that may be used as the white LED 114 of FIG. 1A includes the LED having part number SAWS 1566A_5000K, manufactured by Seoul Semiconductor Co Ltd of Ansan-si, South Korea, and which is specified to operate at 5000K, 720 mA, and 35.2V. Some examples of a commercially available collimating lenses that may be used as the collimating lens 120 of FIG. 1A include lenses having part numbers LB1761-A, LB1761-A*2, LA1951-A, and LB-1761-A(1), which are manufactured by Thorlabs, Inc. of Newton, New Jersey.

The system of FIG. 1A shows a beam of white light 112 entering the dichroic beam splitter 104. The dichroic beam splitter 104 includes features that allow the white light 112 to pass through it but reflect the UV light 122 as discussed herein. One example of a commercially available dichroic beam splitter that may be used as the dichroic beam splitter 104 is beam splitter having part number FF389-Di01-25×36×1.5 manufactured by Semrock of Rochester, New York.

In some examples, the white light LED arrangement could be arranged with a dichroic beam splitter 104 such that it reflects off the dichroic beam splitter 104 to the target. Either option is available in any arrangement or permutation.

In some examples, a non-dichroic beam splitter may be used such as but not limited to 50/50, 60/40, 70/30, 80/20, or 90/10 beam splitter. In some examples, a polarization beam splitter cube to transmit/reflect part of white/UV light intensity to the output may be used instead. Any alternative or permutation of these beam splitters may be used as described herein.

Once through the dichroic beam splitter 104, or reflected by the dichroic beam splitter 104, the beam of white light 112 may pass through to a fiber optic line 142. Such a fiber optic line 142 could be any length and direct the combined light 132 to any number of end systems such as but not limited to a ring light 144. In some examples, the right light 144 may be configured to surround or otherwise direct light to the target, in the example, a gemstone 102 (e.g., a diamond). In some examples, a direct light may be used to illuminate the target 102 instead of, or in addition to the fiber optic line 142 and/or ring light 144.

Also shown in the example of FIG. 1A is a UV LED 124 used to generate a beam of UV light 122. One example of a commercially available UV LED that may be used as the UV LED 124 of FIG. 1A is the LED having part number M365L3 manufactured by Thorlabs, Inc. of Newton, New Jersey. In some examples, a spectrum produced by the UV LED 124 may include a single band with wavelengths centered at 365, 375, 385, or 395 nm or multiple bands between 365 to 400 nm.

In some examples, the UV LED 124 is in thermal contact with a heat sink 134. Such a heat sink 134 may include or be attached to or otherwise in contact with a UV LED temperature sensor 146 that may be in communication with a computer system 148 for sending and receiving UV LED temperature data 150 regarding the UV heat sink 116 and/or the UV LED 124 as discussed above for the white LED 114 arrangement. This temperature of the heat sink 116 and/or UV LED 124 may be monitored by the computer system 148 automatically by software and/or manually with a display of temperature data on a computer display for a human user as described herein (e.g., via the graphical user interface 160).

In some examples, a UV LED current sense resistor 156 may be used to estimate an electrical current provided to the UV LED 124. By way of non-limiting example, the UV LED current sense resistor 156 may be placed in series with or in parallel with the UV LED 124, and a voltage potential across the UV LED current sense resistor 156 may be detected. A known resistance of the UV LED current sense resistor 156, estimated electrical impedance of the UV LED 124, and a known voltage potential across the UV LED current sense resistor 156 may be used to estimate the electrical current provided to the UV LED 124. In some examples, UV LED current feedback 158 may be provided to the computer system 148 to enable the computer system 148 to estimate the electrical current provided to the UV LED 124. By way of non-limiting example, the UV LED current feedback 158 may be indicative of a voltage potential across of the UV LED current sense resistor 156. The computer system 148 may use the determined electrical current provided to the UV LED 124 to estimate a brightness/intensity of the UV LED 124. By way of non-limiting example, the computer system 148 may correlate various electrical current values with corresponding estimated brightness/intensity values. As a result, given a determined electrical current provided to the UV LED 124, the computer system 148 may determine a corresponding estimated brightness/intensity value. Interpolation (e.g., linear interpolation) between stored values for the electrical current and the corresponding brightness/intensity and/or extrapolation may be used to estimate the brightness/intensity of the UV LED 124 based on determined electrical current values that do not exactly match those stored by the computer system 148.

The system 100 includes a UV LED lens 126 and an ND filter 128 in front of the UV LED 124. The UV LED lens 126 may collimate the UV light 122. One example of a commercially available lens that may be used as the UV LED lens 126 includes an aspheric condenser lens having part number ACL-1210U manufactured by Thorlabs, Inc of Newton, New Jersey. The ND filter 128 may be used to reduce the brightness/intensity of the UV LED 124 while enabling the UV LED 124 to operate under desirable (e.g., optimal) current conditions in order to provide a stable output. One example of a commercially available filter that may be used as the ND filter 128 is a filter having part number NE04B manufactured by Thorlabs, Inc. of Newton, New Jersey.

A desired resultant beam of combined light 132 may only include a relatively small percentage of UV light 122 compared to a relatively larger percentage of white LED 114 in combined light 132 provided to the gemstone 102. Commercially available LEDs that emit light in the UV spectrum, however, may tend to be relatively bright and may produce more UV light 122 than would be useful to the system 100. One way to reduce the amount of UV light 122 provided by the UV LED 124 would be to reduce the amount of electrical current provided to the UV LED 124. To reduce the amount of UV light 122 provided by the UV LED 124 to meet the desired intensity of the UV LED 124, however, commercially available UV LEDs may tend to operate in an unstable state (i.e., more current corresponding to higher intensity than would be useful to the system 100 may generally place commercially available UV LEDs in a more stable operational state). Accordingly, rather than reduce the amount of electrical current provided to the UV LED 124 to the point where the UV LED 124 operates in an unstable state, the ND filter 128 may be positioned in front of the UV LED 124 to reduce the intensity of the UV light 122 arriving at the dichroic beam splitter 104 to useful levels while operating the UV LED 124 in a stable state that would otherwise correspond to more intense light 122 than would be useful. In such a way, the filtered UV light 122 enters the dichroic beam splitter 104 at a desired or target intensity without operating the UV LED 124 at unstable current levels.

The dichroic beam splitter 104 in the example system 100 of FIG. 1A is configured to reflect the beam of UV light 122 toward the target fiber optic line 142 and/or gemstone 102. By so doing, when the white LED 114 is generating a beam of white light 112, the dichroic beam splitter 104 may combine the two light beams (the beam of white light 112 and the beam of UV light 122) in a beam of combined light 132. This beam of combined light 132 may include the various advantageous properties desired for proper illumination of a gemstone 102 for color grading as discussed herein. By way of non-limiting example, the combined light 132 may approximate illumination from a halogen lamp.

The system of FIG. 1A also shows example lenses 138, 140 to help direct and focus the beam of combined light 132 from the dichroic beam splitter 104 toward the target fiber optic line 142 or gemstone 102. In the example illustrated in FIG. 1A, two lenses, lens 138 and lens 140, are shown. In various embodiments, however, lens arrangements may include one, two, or even more than two lenses. Commercially available examples of lenses that may be used as the lenses 138 and 140 include lenses having part numbers LA1951-A and LB1761-A manufactured by Thorlabs, Inc. of Newark, New Jersey. Another combination of commercially available examples of lenses that may be used as the lenses 138 and 140 include lenses having part numbers LA-1951-A and LB-1761-A(2) manufactured by Thorlabs, Inc.. These lenses 138, 140 may be used to create a light distribution similar to a commercially available halogen lamp having part number KL 1500 manufactured by Schott AG of Mainz, Germany.

In some examples, a spectrometer 162 may be used to record spectrum data 164 indicating the LED total spectrum at any of the beam of white light 112, the beam of UV light 122, or the beam of combined light 132. The spectrometer 162 may provide the spectrum data 164 to the computer system 148. Using information or data from the spectrometer 162, the computer system 148 may adjust applied current of the UV LED 124 and/or white LED 114 to set the ratio between the two beams into the beam of combined light 132 to a desired level. This arrangement allows for checking or monitoring of the ratio regularly, for example, on a daily or weekly basis by computer software (e.g., executed by the computer system 148) and/or by a human operator interacting with the graphical user interface 160 displayed on a computer display, which may display the spectrum data 164.

The arrangement of FIG. 1A allows for measurement of a gemstone 102 (e.g., a diamond) with strong fluorescence in a colorimeter or other color evaluation system to set the UV to white intensity ratio to a desired level. Such an arrangement allows a user or automatic system to slightly adjust the output of the UV LED 124 and find a lower and higher limit of UV to white LED ratio. Such arrangement allows a user or automatic system to slightly increase/reduce the current of the UV LED 124 until the colorimeter reading falls out of an acceptable range.

FIG. 1B is an isometric view of the example system 100 illustrated by FIG. 1A taken from a perspective angle and with some three-dimensional parts shown. The reference numerals in FIG. 1B reference the same parts as those discussed above with reference to FIG. 1A. For example, the system 100 illustrated in FIG. 1B illustrates non-limiting examples of the dichroic beam splitter 104, the white LED 114, the heat sink 116, the color filter 118, the collimating lens 120, the UV LED 124, the UV LED lens 126, the ND filter 128, the cooling fan 130, the heat sink 134, the lens 138, and the lens 140 discussed above with reference to FIG. 1A.

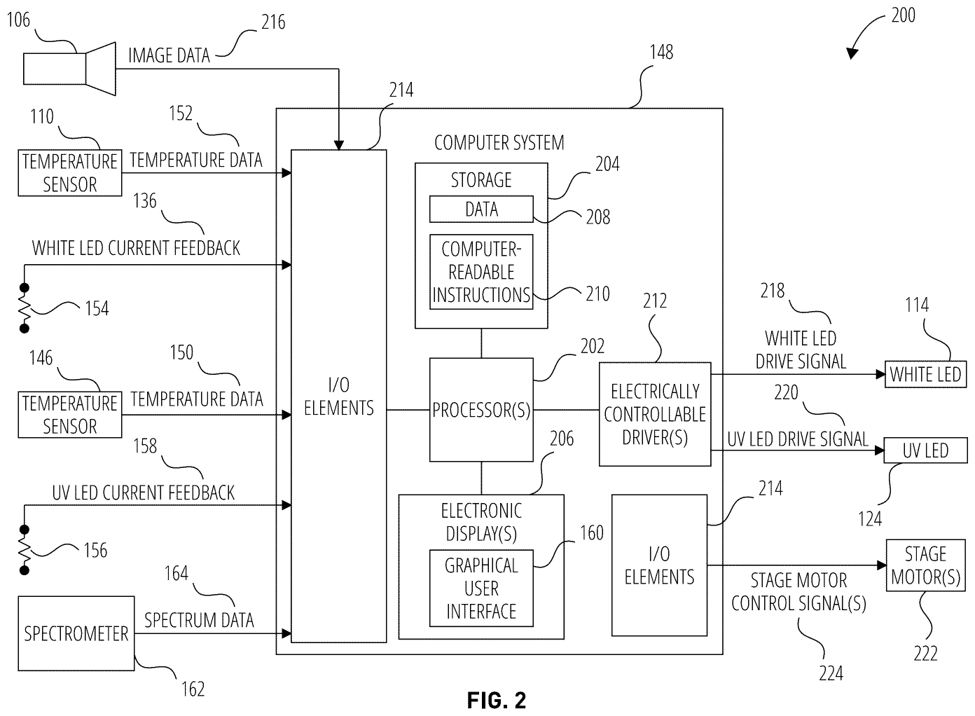

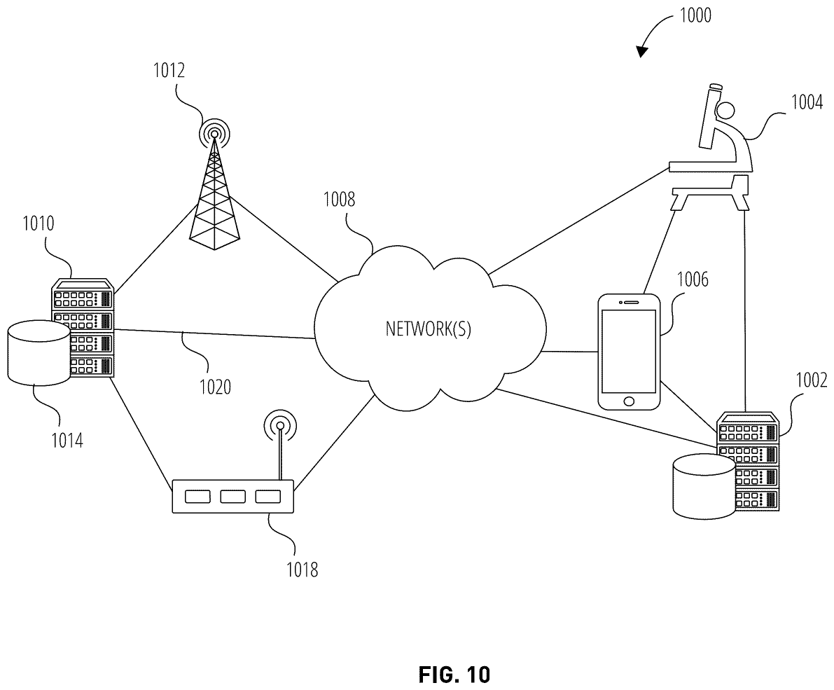

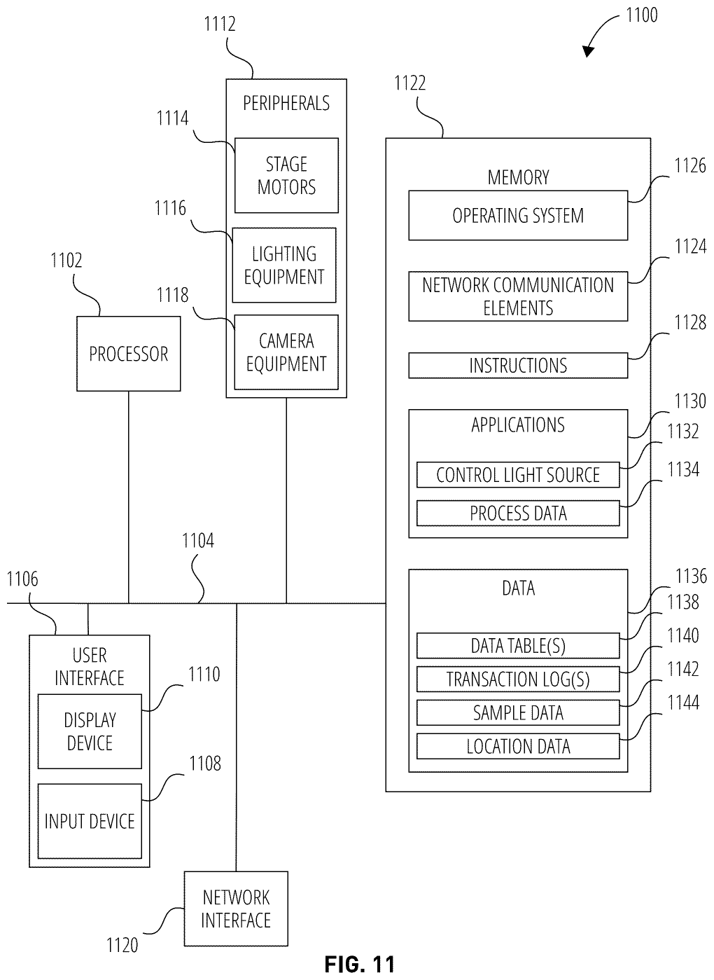

In some examples, the system 100 disclosed herein may be arranged to automatically monitor or self-monitor using computers (e.g., the computer system 148 of FIG. 1B) and software (e.g., executed as computer-readable instructions 210 (FIG. 2) by the computer system 148) running on computers, to allow for adjustments of the output light as needed for various purposes and applications. Such monitoring may include use of a temperature sensor(s) attached to or in close proximity to the heat sink(s) as discussed with reference to FIG. 1A and FIG. 1B. In such system and method examples, computer components such as those discussed with reference to FIG. 2, FIG. 10, and FIG. 11 may be used to collect or receive temperature sensor data from LED and/or heat sink temperature sensors, store and/or analyze the temperature data as disclosed herein, and use that analyzed data to record LED output spectrum(s), monitor the LED output spectrum required, estimate the UV LED 124 brightness/intensity, and/or estimate the white LED 114 brightness/intensity, in any permutation or combination. Additionally or alternatively, in some examples, current sense resistors (e.g., white LED current sense resistor 154, UV LED current sense resistor 156 of FIG. 1A) may be used to provide feedback on the current draw of each LED. This may provide a more direct assessment of each LEDs brightness to be used in the analysis and adjustments discussed herein.

FIG. 2 is a block diagram of an electrical system 200, according to some embodiments. The electrical system 200 includes the camera 106, the white LED temperature sensor 110, the white LED current sense resistor 154, the UV LED temperature sensor 146, the UV LED current sense resistor 156, the spectrometer 162, the computer system 148, the white LED 114, and the UV LED 124 discussed with reference to FIG. 1A. The electrical system 200 also includes one or more stage motors 222 mechanically coupled to the stage 168 of FIG. 1A.

The computer system 148 includes one or more processors 202, one or more data storage devices 204 operably coupled to the one or more processors 202, input/output elements 214 operably coupling the one or more processors 202 to various components of the electrical system 200, one or more electrically controllable drivers 212 operably coupled to the one or more processors 202, and one or more electronic displays 206. The input/output elements 214 operably couple the camera 106, the white LED temperature sensor 110, the white LED current sense resistor 154, the UV LED temperature sensor 146, the UV LED current sense resistor 156, the spectrometer 162, and the one or more stage motors 222 to the one or more processors 202. Accordingly, the camera 106 provides image data 216 corresponding to digital images, the white LED temperature sensor 110 provides white LED temperature data 152, the white LED current sense resistor 154 provides white LED current feedback 136, the UV LED temperature sensor 146 provides UV LED temperature data 150, the UV LED current sense resistor 156 provides UV LED current feedback 158, and the spectrometer 162 provides spectrum data 164 to the one or more processors 202 via the input/output elements 214.

The one or more processors 202 control the one or more electrically controllable drivers 212 to provide a white LED drive signal 218 and a UV LED drive signal 220 to the white LED 114 and the UV LED 124, respectively. The one or more processors 202 control the one or more electrically controllable drivers 212 to adjust the white LED drive signal 218 and the UV LED drive signal 220 to adjust electrical currents provided to the white LED 114 and the UV LED 124, respectively. In this way, the one or more processors 202 may control brightness/intensity levels of the white LED 114 and the UV LED 124 according to various embodiments disclosed herein.

The one or more processors 202 also provide one or more stage motor control signals 224 to the one or more stage motors 222 to control operation of the one or more stage motors 222. By way of non-limiting example, the one or more stage motors 222 may include stage motors to translate the stage 168 (FIG. 1A) in one, two, or three dimensions (e.g., up to two horizontal directions perpendicular to each other and/or a vertical direction) and/or tilt the stage 168 at various different angles relative to horizontal. By way of non-limiting example, the one or more processors 202 may control the one or more stage motors 222 to tilt the stage 168 (FIG. 1A) at various different angles and the camera 106 may capture digital images of the sample (e.g., the gemstone 102 of FIG. 1A) tilted at each of the various different angles. Measurements (provided by image data 216 from the camera 106) of the sample at these various different angles may be averaged, and the average value may be more reliable or accurate than a value taken of the sample at only a single tilt angle.

The one or more electronic displays 206 may be configured to present a graphical user interface 160 thereon. The graphical user interface 160 may enable a user to interact with the system 100. For example, the graphical user interface 160 may enable the user to set a desired target ratio between white light components and UV light components in the combined light 132 (FIG. 1A). As another example, the graphical user interface 160 may present digital images captured of the sample. The 160 may further enable the user to manually turn on and off the white LED 114 and the UV LED 124, manually adjust the brightness/intensity of the white LED 114 and the UV LED 124, manually adjust a position and/or a tilt angle of the stage 168 (FIG. 1A) via the one or more stage motors 222, view present and/or historical temperature data (e.g., the white LED temperature data 152 and the UV LED temperature data 150), present and/or historical electrical current feedback information (e.g., white LED current feedback 136, UV LED current feedback 158), present and/or historical spectrum data 164, or other information.

The one or more processors 202 may include any of a number of different programmable processing circuits. By way of non-limiting example, the one or more processors 202 may include a central processing unit (CPU), a microcontroller, a programmable logic controller (PLC), a field programmable gate array (FPGA), a graphics processing unit (GPU), other programmable processing circuits, or combinations thereof.

The one or more data storage devices 204 may include one or more volatile data storage devices (e.g., memory such as random-access memory (RAM)), one or more non-volatile data storage devices (e.g., a hard drive or solid-state drive), or combinations of volatile and non-volatile data storage devices. The one or more data storage devices 204 includes data 208 and computer-readable instructions 210 stored thereon. The data 208 may include information taken from image data 216, white LED temperature data 152, white LED current feedback 136, UV LED temperature data 150, UV LED current feedback 158, and/or spectrum data 164 received by the computer system 148. The data 208 may also include target values for desired ratios between white and UV components of the combined light 132 (FIG. 1A), colorimeter grading values to compare to measured colors from image data 216, reference chroma values for comparing to measured chroma values of a sample, desired target LED temperatures for the white LED 114 and/or the UV LED 124, target electrical current values for the white LED 114 and the UV LED 124, other data, or combinations thereof.

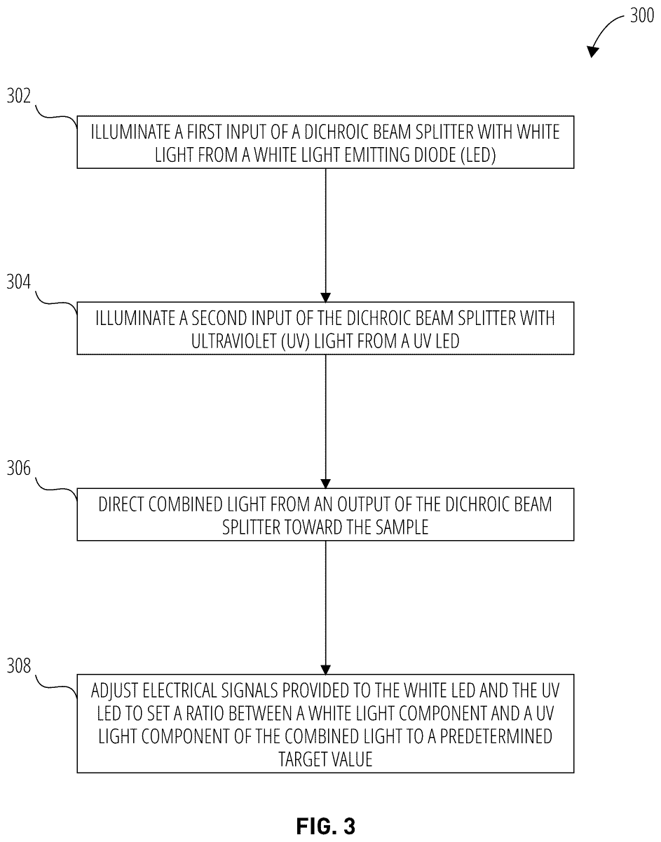

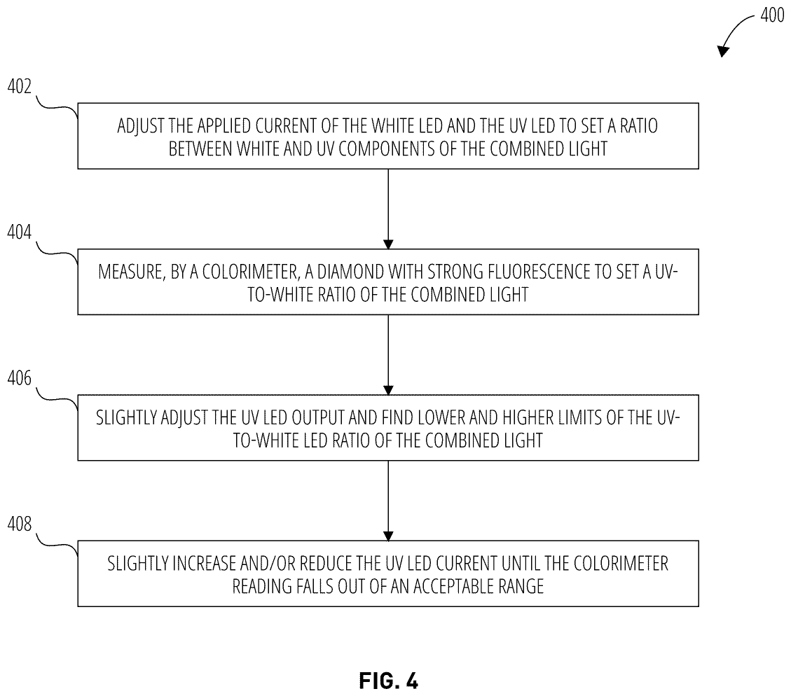

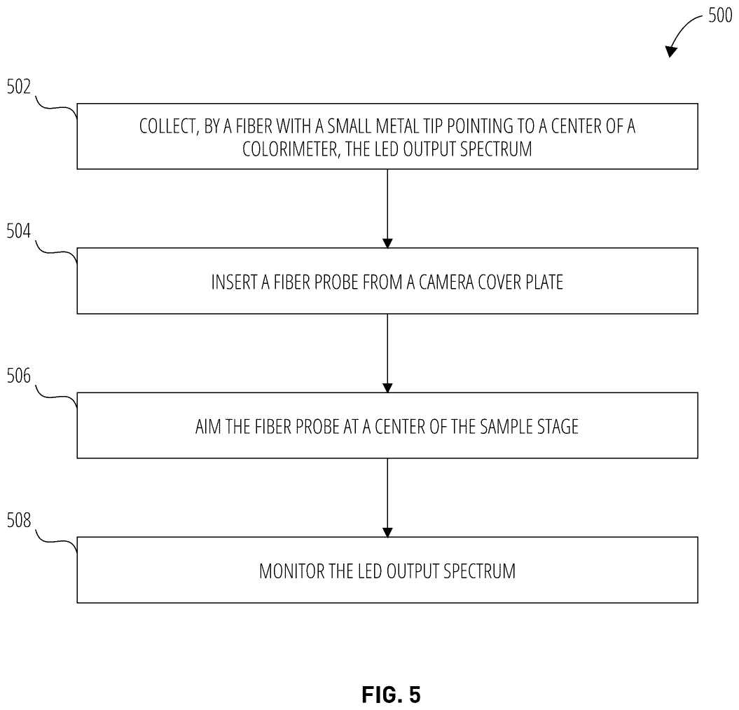

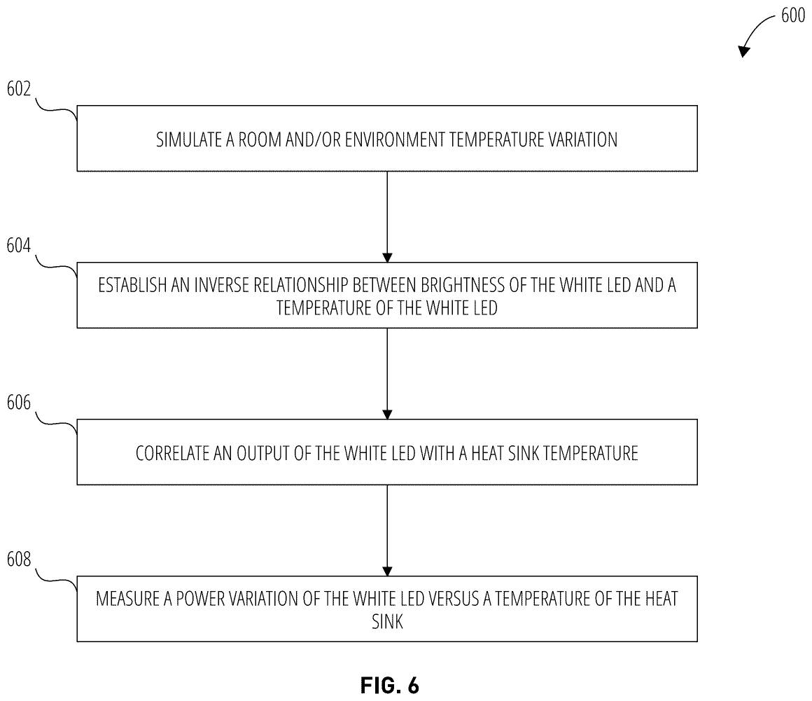

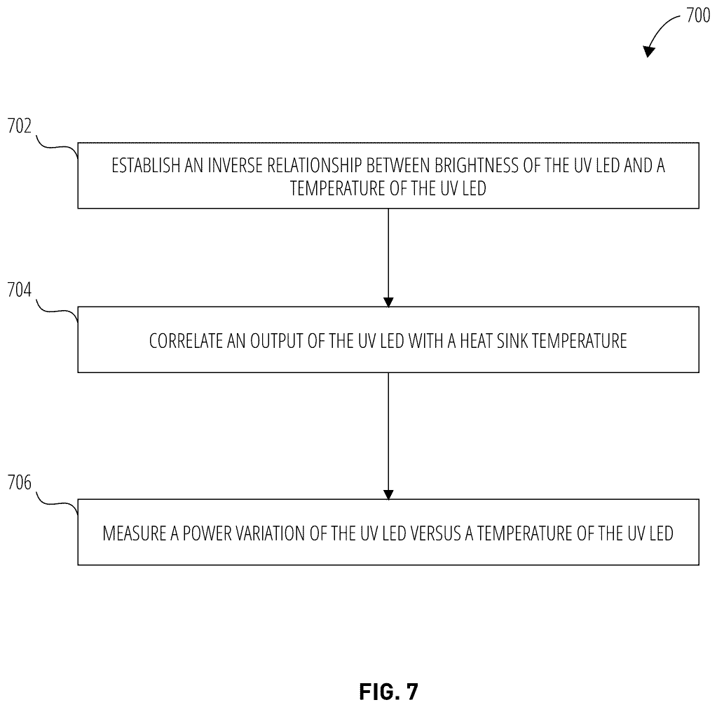

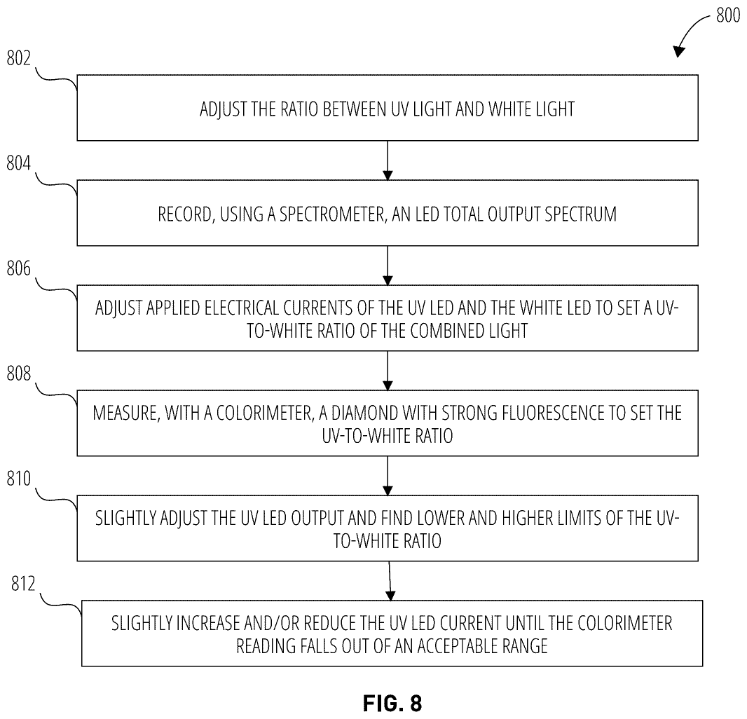

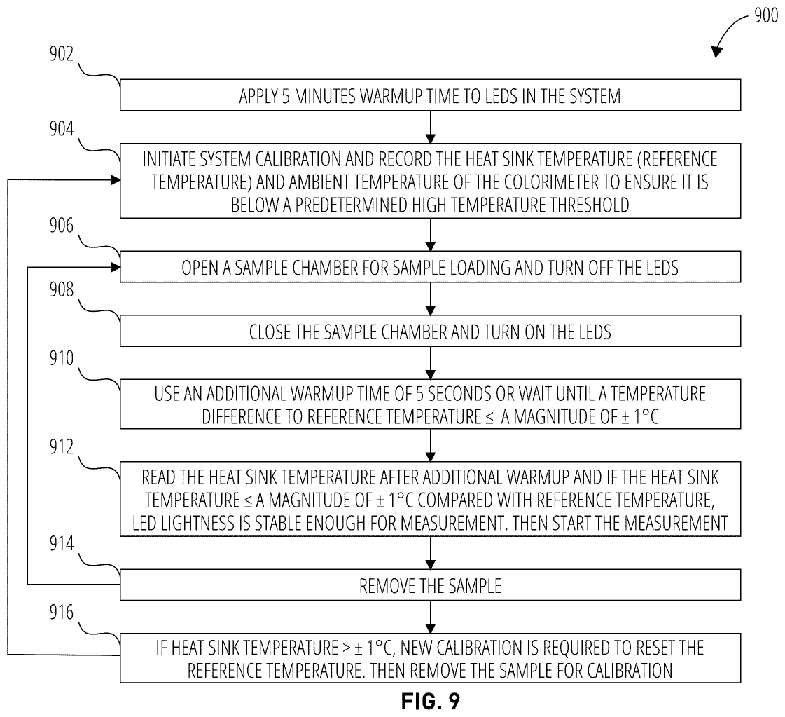

The computer-readable instructions 210 are configured to instruct the one or more processors 202 to perform operations disclosed herein for the computer system 148. By way of non-limiting example, the computer-readable instructions 210 may be configured to instruct the one or more processors to process received data (e.g., image data 216, white LED temperature data 152, white LED current feedback 136, UV LED temperature data 150, UV LED current feedback 158, and spectrum data 164), data 208 stored by the one or more data storage devices 204, and data received from a user via the graphical user interface 160. The computer-readable instructions 210 are also configured to instruct the one or more processors 202 to control the white LED drive signal 218, the UV LED drive signal 220, and the one or more stage motor control signals 224 according to embodiments disclosed herein. Furthermore, the computer-readable instructions 210 are configured to instruct the one or more processors 202 to perform operations discussed herein for the computer system 148. As a further example, the computer-readable instructions 210 may be configured to instruct the one or more processors 202 to perform at least portions of the method 300 of FIG. 3, the method 400 of FIG. 4, the method 500 of FIG. 5, the method 600 of FIG. 6, the method 700 of FIG. 7, the method 800 of FIG. 8, and/or the method 900 of FIG. 9.

In some embodiments, the computer-readable instructions 210 are configured to instruct the one or more processors 202 to perform operations associated with a colorimeter. Accordingly, the computer system 148, the illumination system 170 (FIG. 1A), and the camera 106 may work together to operate as a colorimeter. Accordingly, reference herein to a “colorimeter” may refer to this operation of the computer system 148, the illumination system 170, and the camera 106 as a colorimeter.

FIG. 3 is a flowchart illustrating a method 300 of illuminating a sample, according to some embodiments. At operation 302, the method 300 includes illuminating a first input of a dichroic beam splitter (e.g., the dichroic beam splitter 104 of FIG. 1A) with white light (e.g., the white light 112 of FIG. 1A) from a white LED (e.g., the white LED 114 of FIG. 1A). In some embodiments, illuminating the first input of the dichroic beam splitter with white light includes illuminating the first input through a color filter (e.g., the color filter 118 of FIG. 1A) and a collimating lens (e.g., the collimating lens 120 of FIG. 1A).

At operation 304, the method 300 includes illuminating a second input of the dichroic beam splitter with UV light (e.g., the UV light 122 from a UV LED (e.g., the UV LED 124 of FIG. 1A). In some embodiments, illuminating the second input of the dichroic beam splitter with UV light includes illuminating the second input through an ND filter.

At operation 306, the method 300 includes directing combined light (e.g., combined light 132 of FIG. 1A) from an output of the dichroic beam splitter toward the sample (e.g., the gemstone 102 of FIG. 1A). In some embodiments, directing the combined light toward the sample includes directing the combined light to a fiber optic line (e.g., fiber optic line 142 of FIG. 1A) and transmitting the combined light through the fiber optic line to a ring light (e.g., the ring light 144 of FIG. 1A) proximate to the sample.

At operation 308, the method 300 includes adjusting electrical signals (e.g., white LED drive signal 218, UV LED drive signal 220 of FIG. 2) provided to the white LED and the UV LED to set a ratio between a white light component and a UV light component of the combined light to a predetermined target value. In some embodiments, adjusting the electrical signals includes adjusting the electrical signals based on one or more of measured temperatures associated with the white LED and the UV LED, measured currents provided to the white LED and the UV LED, or spectrometer measurements taken of one or more of the white light, the UV light, or the combined light.

FIG. 4 is a flowchart illustrating a method 400 of operating an illumination system (e.g., the illumination system 170 of FIG. 1A), according to some embodiments. As discussed with reference to FIG. 1A and FIG. 2, a spectrometer (e.g., spectrometer 162 of FIG. 1A and FIG. 2) may be used to measure spectrum data (e.g., spectrum data 164) indicating measured spectral components of the combined light 132 (FIG. 1A). This measured spectrum data may be used in performing the method 400.

At operation 402, the method 400 includes adjusting the applied current of the white LED (e.g., the white LED 114 of FIG. 1A) and the UV LED (e.g., the UV LED 124 of FIG. 1A) to set a ratio between white and UV components of the combined light (e.g., the combined light 132). At operation 404, the method 400 includes measuring, by a colorimeter, a diamond with strong fluorescence to set a UV-to-white ratio of the combined light. At operation 406, the method 400 includes slightly adjusting the UV LED output and finding lower and higher limits of the UV-to-white ratio of the combined light. At operation 408, the method 400 includes slightly increasing and/or/reducing the UV LED current until the colorimeter reading falls out of an acceptable range. By way of non-limiting example, an operating current of the UV LED may be 285 mA (5.875 mW) with an upper limit of 315 mA (6.528 mW) or +11%; a lower limit of 255 mA (5.224 mW) or −11%.

FIG. 5 is a flowchart illustrating a method 500 of monitoring an LED output spectrum. At operation 502, the method 500 includes collecting, by a fiber with a small metal tip pointing to a center of a colorimeter, the LED output spectrum. At operation 504, the 500 includes inserting a fiber probe from a camera cover plate. At operation 506, the method 500 includes aiming the fiber probe at a center of a sample stage (e.g., the stage 168 of FIG. 1A). At operation 506, the method 500 includes monitoring the LED output spectrum. The method 500 may, without using moving parts, aid use of a fiber and produce results that are reasonably close to the actual spectrum that illuminates the sample.

FIG. 6 is a method 600 of estimating brightness of a white LED (e.g., the white LED 114 of FIG. 1A, FIG. 1B, and FIG. 2), according to some embodiments. LED brightness may be correlated to LED temperature (e.g., heat sink or LED chip temperature). If LED temperature changes, it may be determined that a brightness of the LED has also changed. If temperature varies beyond predetermined limit values, a recalibration may be helpful to bring operation back within the predetermined limit values. A sample may be removed from a stage (e.g., the stage 168 of FIG. 1A) for a calibration (e.g., a recalibration) operation. The method 600 may be used to check up on LED temperature during use of a system such as the system 100 of FIG. 1A.

In some examples, a system may be used for analyzing and using heat sink temperature data readings from a sensor attached to or proximate to the heat sinks as discussed with reference to FIG. 1A to estimate the white LED brightness. At operation 602, the method 500 includes simulating a room and/or environment temperature variation. At operation 604, the method 600 includes establishing an inverse relationship between brightness of the white LED and a temperature of the white LED. At operation 606, the method 600 includes correlating an output of the white LED with a heat sink temperature (e.g., an output of the white LED 114 with a temperature of the heat sink 116 of FIG. 1A). At operation 608, the method 600 includes measuring a power variation of the white LED versus a temperature of the white LED. By way of non-limiting example, the power variation versus the temperature may be around 0.22%/° C.

FIG. 7 is a method 700 of estimating a brightness of a UV LED (e.g., the UV LED 124 of FIG. 1A, FIG. 1B, and FIG. 2), according to some embodiments. In some instances, a UV LED may be more sensitive to, yet have a bigger tolerance for, temperature fluctuations. A heat sink temperature of a heat sink associated with the UV LED may be used to estimate brightness of the UV LED. At operation 702, the method 700 includes establishing an inverse relationship between a brightness of the UV LED and a temperature of the UV LED. At operation 704, the method 700 includes correlating an output of the UV LED with a heat sink temperature. At operation 706, the 700 includes measuring a power variation of the UV LED versus a temperature of the UV LED. By way of non-limiting example, the power variation of the UV LED versus the temperature of the UV LED may be around ±0.40%/° C.

FIG. 8 is a method 800 of illuminating a sample (e.g., a gemstone such as the gemstone 102 of FIG. 1A), according to some embodiments. The method 800 may be used to set a ratio between white and UV components of combined light (e.g., the combined light 132) that illuminates the sample. For example, UV light may reduce a Chroma value of a strong fluorescence diamond. A target UV-to-white ratio of the combined light may be determined by the Chroma value from colorimeter measurement(s). Upper and lower limits of the UV-to-white ratio may be the acceptable lower and upper Chroma value boundaries of a selected reference strong fluorescence diamond.

At operation 802, the method 800 includes adjusting the ratio between UV light and white light in the combined light. At operation 804, the method 800 includes recording, using a spectrometer, an LED total output spectrum of the combined light. At operation 806, the method 800 includes adjusting applied electrical currents of the UV LED and the white LED to set a UV-to-white ratio of the combined light. At operation 808, the method 800 includes measuring, with a colorimeter, a diamond with strong fluorescence to set the UV-to-white ratio. At operation 810, the method 800 includes slightly adjusting the UV LED output and finding lower and higher limits of the UV-to-white ratio. At operation 812, the method 800 includes slightly increasing and/or reducing the UV LED current until the colorimeter reading falls out of an acceptable range. In some examples, the method 800 may use a fiber with a small metal tip that points to the center of the colorimeter to collect the LED output spectrum.

To calibrate the system, a user may insert a fiber probe from a camera cover plate and aim the fiber probe at a center of a sample stage. This method has no moving parts, which reduces wear and tear on fiber optic cables compared to mechanically moving systems. Further, results may be reasonably close to an actual spectrum illuminated to the sample. The system may monitor the LED brightness using the heat sink temperature and/or junction temperature, as sensed by a temperature probe to estimate the white LED brightness, based on previously recorded calibrations.

Additionally or alternatively, in some examples, current sense resistors may be used to provide feedback on the current draw of each LED. This may provide a more direct assessment of each LED's brightness.

Additionally or alternatively, in some examples, the systems may be used to automate control of the UV LED intensity and the white LED intensity by using current feedback from current sense Integrated Chips on an example control board. By monitoring the current draw of each LED and comparing it against a known UV to white LED drive current ratio, a PID control sequence may be added to implement a closed-loop control sequence that continuously maintains a target ratio between white LED and UV LED intensity.

Embodiments disclosed herein may simulate room and/or environment temperature variation. Embodiments disclosed herein may show an inverse relationship between white LED output and temperature. In such examples, the white LED output has a better correlation with heat sink temperature. And in some examples, the power variation vs temperature may be measured (e.g., approximately ±0.22%/° C.).

Minimizing the LED brightness variation between a reference value (e.g., a target value) and actual measurement may be useful to minimize variation in the calculated Lightness value in a color analysis tool such as a colorimeter. When the Lightness values change, a new calibration or reference may be applied to the colorimeter. In halogen systems, a calibration may be performed every 3 minutes. By contrast, in a temperature monitored LED system according to various embodiments disclosed herein, temperature may be detected and calibration may only be performed when a detected variation in LED brightness between reference and measurement is shown to be more than a predetermined tolerance value. Thus, the systems and methods disclosed herein may save time for over frequent halogen system calibration while maintaining accuracy in color measurement.

FIG. 9 is flowchart illustrating another method 900 of illuminating a sample, according to some embodiments. At operation 902, the method 900 includes applying 5 minutes warmup time to LEDs in the system. At operation 904, the method 900 includes initiating system calibration and recording the heat sink temperature (reference temperature) and ambient temperature of the colorimeter to ensure it is below a predetermined high temperature threshold. At operation 906, the method includes opening a sample chamber for sample loading and turning off the LEDs (e.g., to avoid human exposure to potentially harmful UV radiation and/or white radiation). At operation 908, the method includes closing the sample chamber and turning on the LEDs. At operation 910, the method 900 includes using an additional warm up time of 5 seconds or waiting until a temperature difference to reference temperature is less than or equal to a magnitude of 1° C. At operation 912, the method includes reading the heat sink temperature after additional warmup, and if the heat sink temperature is less than or equal to a magnitude of 1° C. compared with reference temperature, LED lightness is stable enough for measurement. Then start the measurement. At operation 914, the method 900 includes removing the sample, and returning to operation 906. At operation 916, if the heat sink temperature is greater than a magnitude of 1° C. from the reference temperature, a new calibration may be required to reset the reference temperature, then remove the sample for calibration and the method 900 proceeds to operation 904. This value may depend on the acceptable brightness range and the power variation versus temperature and may differ, depending on the application. These ranges may depend on the acceptable brightness range and the power variation versus temperature, and this is merely an example.

In some embodiments, the method 900 may be automated. For example, the LEDs may automatically turn off by computer command, while the sample chamber is open, for safety, and automatically turn on when the chamber lid is closed, using information from micro-switches placed in, on, or near the chamber lid to sense whether the lid is open or closed and send that data to a computer. This interlock function may reduce the likelihood of eye hazards. For example, blocking the strong white and UV light from the light source when the user has access to the exit port of the light may reduce the likelihood of the strong white and UV light entering a user's eye.

Various systems and methods disclosed herein may utilize a networked computing arrangement 1000 as shown in FIG. 10. The networked computing arrangement 1000 includes a lighting system 1004 (e.g., the system 100 of FIG. 1A and FIG. 1B) and a computer 1002 (e.g., the computer system 148 of FIG. 1A and FIG. 2). The computer 1002 may be used to process pixel data of captured images of a camera (e.g., the camera 106 of FIG. 1A). The computer 1002 may also be used to send and receive instructions to stage motors (e.g., the one or more stage motors 222 of FIG. 2), or send and receive other data such as sample location, identification information of the gemstones, time and date, etc. The computer 1002 used for these operations may be any number of kinds of computers such as those included in the camera itself, and/or another computer arrangement in communication with the camera components including but not limited to a laptop, desktop, tablet, phablet, smartphone 1006, or any other kind of device used to process and transmit digitized data.

Referring once again to FIG. 10, the data captured for the pixelated image, calibration file, stone sample identifying information, and/or location, from whichever computer 1002 may be analyzed on a back-end computer 1010 instead of or in addition to a local computer (e.g., the computer 1002). In such examples, data may be transmitted to a back-end computer 1010 and associated data storage 1014 via one or more network(s) 1008 for saving, analysis, computation, comparison, or other manipulation. In some examples, additionally or alternatively, the transmission of data may be wireless by cellular data networks 1012 or via Wi-Fi transmission with associated routers and hubs 1018. In some examples, additionally or alternatively, the transmission may be through a wired connection 1020. In some examples, additionally or alternatively, the transmission may be through a network such as the internet to the back-end computer 1010 and associated data storage 1014.

At the back-end computer 1010 and associated data storage 1014, the pixelated image data, calibration file, sample identification, sample location, time, and/or date may be stored, analyzed, compared to previously stored image data and/or wireframe data for matching, identification, and/or any other kind of data analysis. In some examples, additionally or alternatively, the storing, analyzing, and/or processing of data may be accomplished at the computer 1002, which may be involved in the original image capture and/or data collection. In some examples, additionally or alternatively, the data storing, analyzing, and/or processing may be shared between the local computer 1002 and a back-end computer 1010. In such examples, networked computer resources may allow for more data processing power to be utilized than may be otherwise available at the local computers 1002. In such a way, the processing and/or storage of data may be offloaded to the compute resources that are available. In some examples, additionally or alternatively, the networked computer resources may be virtual machines in a cloud or distributed infrastructure. In some examples, additionally or alternatively, the networked computer resources may be spread across multiple physical or virtual computer resources by a cloud infrastructure. The example of a server implemented as a single back-end computer 1010 is not intended to be limiting and is only one example of a compute resource that may be utilized by the systems and methods described herein. In some examples, additionally or alternatively, artificial intelligence and/or machine learning may be used to analyze the image data from the samples, align the sample with the camera and/or focus the imaging camera for use with stage movement. Such systems may employ data sets to train algorithms to help produce better and better results of imaging of samples, alignment of samples, analysis of samples, identification of focused samples, stage movement, camera movement, and the like.

FIG. 11 is a block diagram of an example computing system 1100 that may be used in systems and methods disclosed herein. The computing system 1100 may be an example of the computer system 148 of FIG. 1A and FIG. 2). The example computing system 1100 includes a central processing unit (CPU) or processor 1102 in communication, by communication elements 1104 (e.g., a bus or other communication elements), with a user interface 1106. The user interface 1106 includes an example input device 1108 such as a keyboard, mouse, touchscreen, button, joystick, or other user input device(s). The user interface 1106 also includes a display device 1110 such as a screen. The communication elements 1104 are in communication with the processor 1102 and other components. The network interface 1120 may allow the computing system 1100 to communicate with other computers, databases, networks, user devices, or any other computing capable devices. In some examples, additionally or alternatively, the method of communication may be through WIFI, cellular, Bluetooth Low Energy, wired communication, or any other kind of communication. In some examples, additionally or alternatively, the example computing system 1100 includes peripherals 1112 also in communication with the processor 1102. For the LED light control, the computing system 1100 may interface with a control board via USB, but may include any other communication protocol, via an MCU. The MCU controls the white and UV LED (e.g., the white LED 114 and the UV LED 124 of FIG. 1A, FIG. 1B, and FIG. 2) intensity. In addition, it passes relevant control data (e.g., white LED temperature, UV LED temperature, internal colorimeter temperature, LED electrical current values) between the processor 1102 and the lighting equipment 1116 (e.g., the illumination system 170).

In some examples, additionally or alternatively, peripherals include stage motors 1114 (e.g., the one or more stage motors 222 of FIG. 2) such as electric servo and/or stepper motors used for moving the stage (e.g., the stage 168 of FIG. 1A) for the sample analysis. In some examples peripherals 1112 may include camera equipment 1118, and/or lighting equipment 1116. In some examples, computing system 1100 includes a memory 1122 in communication with the processor 1102. In some examples, additionally or alternatively, this memory 1122 may include instructions to execute software such as an operating system 1126, network communication elements 1124, other instructions 1128, applications 1130 (applications to control light sources 1132, applications to process data 1134 such as image pixels), data 1136 (e.g., data tables 1138, transaction logs 1140, sample data 1142, sample location data 1144, or any other kind of data).

### EXAMPLES

A non-exhaustive, non-limiting list of example embodiments follows. Not each of the example embodiments listed below are individually indicated as being combinable with all others of the example embodiments listed below and embodiments discussed above. It is intended, however, that these example embodiments are combinable with all other example embodiments and embodiments discussed above unless it would be apparent to one of ordinary skill in the art that the embodiments are not combinable.

Example 1: A system to illuminate gemstones, the system comprising: a high CRI value white LED configured to emit a beam through a color filter and collimation lens and to a dichroic beam splitter; a UV LED configured to emit a beam through a UV lens and through an ND filter to reduce brightness, and to the dichroic beam splitter; a gemstone stage; wherein the dichroic beam splitter configured to combine the white LED beam and UV beam and direct the combined beam through a second lens and through a third lens to a fiber, wherein the fiber is in communication with a ring light configured to illuminate the gemstone stage; wherein the white LED and UV LED each including a temperature sensor and heat sink and each independently configurable for brightness, the temperature sensors in communication with a computing system with a processor and memory, configured to analyze temperature data from the temperature sensors.

Example 2: A system to illuminate a gemstone, the system comprising: a stage configured to support the gemstone; a high CRI white Light Emitting Diode (LED); a UV LED; a dichroic beam splitter configured to merge a beam of light emitted from the high CRI white Light Emitting Diode (LED) light with a beam of light emitted from the UV LED light to create a resultant beam directed toward the gemstone.

Example 3: The system of Example 2, wherein the UV LED light to white LED light ratio may be adjusted by the computer.

Example 4: The system of Example 3, where the adjustment is to change intensity of either the white or the UV light based on data received from the temperature sensors.

Example 5: The system of Example 3, wherein the adjustment is to change intensity of either the white or the UV light based on data received from current sense resistors that provide feedback on current draws of the white LED and UV LED.

Example 6: The system of Example 2, wherein the high CRI white Light Emitting Diode (LED) light and UV LED light are in thermal contact with a heat sink.

Example 7: The system of Example 6, wherein the high CRI white Light Emitting Diode (LED) light heat sink and the UV LED light heat sink includes a cooling fan.

Example 8: The system of Example 2, wherein the merged UV and white light beam is directed to a fiber in communication with a ring light, the ring light configured approximate to the stage configured to support the gemstone.

Example 9: The system of Example 7, wherein the high CRI white Light Emitting Diode (LED) light heat sink includes a temperature sensor in communication with a computer system having a processor and memory.

Example 10: The system of Example 9, wherein the UV LED light heat sink includes a temperature sensor in communication with the computer system having a processor and memory.

Example 11: The system of Example 10, wherein the heat sink is configured to keep the high CRI white Light Emitting Diode (LED) light operating at a temperature of between 35 and 45 degrees C.

Example 12: The system of Example 10, wherein the heat sink is configured to keep the UV LED light operating at a temperature of between 25 to 40 degrees C.

Example 13: The system of Example 2, wherein the white LED includes a color filter.

Example 14: The system of Example 2, wherein the white LED includes a collimating lens.

Example 15: The system of Example 14, wherein the UV LED includes a neutral density (ND) filter.

Example 16: The system of Example 2, wherein the dichroic beam splitter includes at least one lens to focus the resultant beam toward the gemstone.

Example 17: The system of Example 2, further comprising a spectrometer configured to record the LED total output spectrum at the White LED, the UV LED, and combined resultant beam.

Example 18: The system of Example 2, wherein the white LED and the UV LED are individually adjustable to adjust the output of the respective LED.

Example 19: The system of Example 2, wherein the resultant merged beam has a color temperature between 5000 to 6500K.

Example 20: The system of Example 2, wherein the resultant merged beam has a Color Rendering index (CRI) greater than 90.

Example 21: A method, comprising: receiving, at a computer with a processor and a memory, temperature data from a heat sink in thermal contact with a high CRI white LED; receiving, at the computer, temperature data from a heat sink in thermal contact with a UV LED; receiving, at the computer, spectrometer data from a spectrometer measuring a beam of light including combined light from the high CRI white LED and the UV LED; comparing, at the computer, the spectrometer data to a reference brightness value; and sending commands from the computer to the high CRI white LED and the UV LED to adjust brightness to minimize any difference between the spectrometer data and the reference brightness value.

Example 22: The method of Example 21, wherein the temperature data from the heat sink in thermal contact with the high CRI white LED or UV LED is from an LED case.

Example 23: The method of Example 21, wherein the temperature data from the heat sink in thermal contact with the high CRI white LED or UV LED is from a heat sink substrate.

Example 24: The method of Example 21, further comprising monitoring, by the computer, LED current draw for both the white LED and the UV LED via current sensor ICs on an LED control board.

As disclosed herein, features consistent with the present embodiments may be implemented via computer-hardware, software and/or firmware. For example, the systems and methods disclosed herein may be embodied in various forms including, for example, a data processor, such as a computer that also includes a database, digital electronic circuitry, firmware, software, computer networks, servers, or in combinations of them. Further, while some of the disclosed implementations describe specific hardware components, systems and methods consistent with the innovations herein may be implemented with any combination of hardware, software and/or firmware. Moreover, the above-noted features and other aspects and principles of the innovations herein may be implemented in various environments. Such environments and related applications may be specially constructed for performing the various routines, processes and/or operations according to the embodiments or they may include a computer or computing platform selectively activated or reconfigured by code to provide the necessary functionality. The processes disclosed herein are not inherently related to any particular computer, network, architecture, environment, or other apparatus, and may be implemented by a suitable combination of hardware, software, and/or firmware. For example, various machines may be used with programs written in accordance with teachings of the embodiments, or it may be more convenient to construct a specialized apparatus or system to perform the required methods and techniques.

Aspects of the method and system described herein, such as the logic, may be implemented as functionality programmed into any of a variety of circuitry, including programmable logic devices (“PLDs”), such as field programmable gate arrays (“FPGAs”), programmable array logic (“PAL”) devices, electrically programmable logic and memory devices and standard cell-based devices, as well as application specific integrated circuits. Some other possibilities for implementing aspects include: memory devices, microcontrollers with memory (such as EEPROM), embedded microprocessors, firmware, software, etc. Furthermore, aspects may be embodied in microprocessors having software-based circuit emulation, discrete logic (sequential and combinatorial), custom devices, fuzzy (neural) logic, quantum devices, and hybrids of any of the above device types. The underlying device technologies may be provided in a variety of component types, e.g., metal-oxide semiconductor field-effect transistor (“MOSFET”) technologies like complementary metal-oxide semiconductor (“CMOS”), bipolar technologies like emitter-coupled logic (“ECL”), polymer technologies (e.g., silicon-conjugated polymer and metal-conjugated polymer-metal structures), mixed analog and digital, and so on.

It should also be noted that the various logic and/or functions disclosed herein may be enabled using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the Internet and/or other computer networks via one or more data transfer protocols (e.g., HTTP, FTP, SMTP, and so on).

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

Although certain presently preferred implementations of the descriptions have been specifically described herein, it will be apparent to those skilled in the art to which the descriptions pertain that variations and modifications of the various implementations shown and described herein may be made without departing from the spirit and scope of the embodiments. Accordingly, it is intended that the embodiments be limited only to the extent required by the applicable rules of law.

The present embodiments can be embodied in the form of methods and apparatus for practicing those methods. The present embodiments can also be embodied in the form of program code embodied in tangible media, such as floppy diskettes, CD-ROMs, hard drives, or any other machine-readable storage medium, wherein, when the program code is loaded into and executed by a machine, such as a computer, the machine becomes an apparatus for practicing the embodiments. The present embodiments can also be in the form of program code, for example, whether stored in a storage medium, loaded into and/or executed by a machine, or transmitted over some transmission medium, such as over electrical wiring or cabling, through fiber optics, or via electromagnetic radiation, wherein, when the program code is loaded into and executed by a machine, such as a computer, the machine becomes an apparatus for practicing the embodiments. When implemented on a processor, the program code segments combine with the processor to provide a unique device that operates analogously to specific logic circuits.

The software is stored in a machine-readable medium that may take many forms, including but not limited to, a tangible storage medium, a carrier wave medium or physical transmission medium. Non-volatile storage media include, for example, optical or magnetic disks, such as any of the storage devices in any computer(s) or the like. Volatile storage media include dynamic memory, such as main memory of such a computer platform. Tangible transmission media include coaxial cables; copper wire and fiber optics, including the wires that comprise a bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: disks (e.g., hard, floppy, flexible) or any other magnetic medium, a CD-ROM, DVD or DVD-ROM, any other optical medium, any other physical storage medium, a RAM, a PROM and EPROM, a FLASH-EPROM, any other memory chip, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

The foregoing description, for purpose of explanation, has been described with reference to specific embodiments. However, the illustrative discussions above are not intended to be exhaustive or to limit the embodiments to the precise forms disclosed. Many modifications and variations are possible in view of the above teachings. The embodiments were chosen and described in order to best explain the principles of the embodiments and its practical applications, to thereby enable others skilled in the art to best utilize the various embodiments with various modifications as are suited to the particular use contemplated.

What is claimed is:

1. An illumination system, comprising:
a stage to support a sample thereon;
a first electromagnetic (EM) radiation source to provide first EM radiation;
a second EM radiation source to provide second EM radiation; and
optical equipment to combine at least a portion of the first EM radiation with at least a portion of the second EM radiation to provide combined EM radiation to the stage to illuminate the sample.

2. The illumination system of claim 1, wherein the first EM radiation source includes a white light emitting diode (LED) and the second EM radiation source includes an ultraviolet (UV) LED.

3. The illumination system of claim 2, wherein the white LED, the UV LED, and the optical equipment are selected to approximate filtered halogen illumination with the combined EM radiation, the filtered halogen illumination including halogen illumination filtered by a color adjusting daylight filter.

4. The illumination system of claim 2, wherein the optical equipment includes a dichroic beam splitter to combine the at least a portion of the first EM radiation with the at least a portion of the second EM radiation.

5. The illumination system of claim 4, wherein the optical equipment includes a neutral density (ND) filter between the UV LED and the dichroic beam splitter.

6. The illumination system of claim 4, wherein the optical equipment includes a color filter between the white LED and the dichroic beam splitter, the color filter selected to pass spectral elements associated with sunlight and filter out other spectral elements to mimic a daylight spectrum.

7. The illumination system of claim 1, wherein the optical equipment includes a fiber optic line and a ring light optically coupled to the fiber optic line, the fiber optic line positioned to receive the combined EM radiation and deliver the combined EM radiation to the ring light, the ring light positioned at the stage to illuminate the sample.

8. The illumination system of claim 1, further comprising a computer system configured to control electrical currents provided to the first EM radiation source and the second EM radiation source to control intensities of the first EM radiation source and the second EM radiation source.

9. The illumination system of claim 8, further comprising temperature sensors at the first EM radiation source and the second EM radiation source, wherein the computer system is configured to control the electrical currents provided to the first EM radiation source and the second EM radiation source based, at least in part, on temperature data from the temperature sensors.

10. The illumination system of claim 8, further comprising current sense resistors at the first EM radiation source and the second EM radiation source, wherein the computer system is configured to control the electrical currents provided to the first EM radiation source and the second EM radiation source based, at least in part, on current feedback from the current sense resistors indicative of electrical currents provided to the first EM radiation source and the second EM radiation source.

11. The illumination system of claim 8, further comprising a spectrometer to provide, to the computer system, spectrum data indicating measured spectra of one or more of the first EM radiation, the second EM radiation, or the combined EM radiation, wherein the computer system is configured to control the electrical currents provided to the first EM radiation source and the second EM radiation source based, at least in part, on the spectrum data.

12. The illumination system of claim 1, further comprising heat sinks at the first EM radiation source and the second EM radiation source.

13. The illumination system of claim 1, further comprising a cooling fan at one or more of the first EM radiation source or the second EM radiation source.

14. A method of illuminating a sample, the method comprising:
illuminating a first input of a dichroic beam splitter with white light from a white light emitting diode (LED);
illuminating a second input of the dichroic beam splitter with ultraviolet (UV) light from a UV LED; and
directing combined light from an output of the dichroic beam splitter toward the sample.

15. The method of claim 14, further comprising adjusting electrical signals provided to the white LED and the UV LED to set a ratio between a white light component and a UV light component of the combined light to a predetermined target value.

16. The method of claim 15, wherein adjusting the electrical signals comprises adjusting the electrical signals based on one or more of:
measured temperatures associated with the white LED and the UV LED;
measured currents provided to the white LED and the UV LED; or
spectrometer measurements taken of one or more of the white light, the UV light, or the combined light.

17. The method of claim 14, wherein illuminating the first input of the dichroic beam splitter with white light comprises illuminating the first input through a color filter and a collimating lens.

18. The method of claim 14, wherein illuminating the second input of the dichroic beam splitter with UV light comprises illuminating the second input through a neutral density filter.

19. The method of claim 14, wherein directing the combined light toward the sample comprises directing the combined light to a fiber optic line and transmitting the combined light through the fiber optic line to a ring light proximate to the sample.

20. The method of claim 14, further comprising cooling the white LED with a cooling fan.
